(19) United States
(12) Patent Application Publication
(10) Pub. No.: US 2023/0201806 A1
(43) Pub. Date: Jun. 29, 2023

(54) CATALYST COMPOSITION, HYDROCARBON PARTIAL OXIDIZER, AND FUEL CELL SYSTEM

(71) Applicants: MITSUI MINING & SMELTING CO., LTD., Tokyo (JP); HONDA MOTOR CO., LTD., Tokyo (JP)

(72) Inventors: Jun SAWADA, Saitama (JP); Wataru ISHII, Saitama (JP); Daisuke KURASHINA, Saitama (JP); Hiroki HOMMA, Saitama (JP); Takamitsu KINO, Saitama (JP)

(21) Appl. No.: 18/087,920

(22) Filed: Dec. 23, 2022

(30) Foreign Application Priority Data
Dec. 24, 2021 (JP) 2021-211477

(51) Int. Cl. B01J 23/63; B01J 21/04; B01J 21/06; B01J 35/00; C01B 3/26; H01M 8/0612; C01B 32/40

(52) U.S. Cl. CPC B01J 23/63; B01J 21/04; B01J 21/066; B01J 35/0006; C01B 3/26; H01M 8/0618; H01M 8/0631; C01B 32/40; C01B 2203/0261; C01B 2203/06; C01B 2203/107

(57) ABSTRACT

An object of the present invention is to provide a catalyst composition that partially oxidizes a hydrocarbon to produce hydrogen and carbon monoxide, the catalytic activity of which is unlikely to deteriorate even when the catalyst composition is exposed to a high temperature, and the present invention provides a catalyst composition that partially oxidizes a hydrocarbon to produce hydrogen and carbon monoxide, including: a carrier that contains α-alumina; and a supported components that are supported on the carrier, wherein the supported components includes at least one platinum group element, a Ce oxide, and a Zr oxide.

### CROSS-REFERENCE TO RELATED APPLICATIONS

The present application is based upon and claims the benefit of priority from Japanese Patent Application No. 2021-211477, filed Dec. 24, 2021; the entire contents of which are incorporated herein by reference.

### BACKGROUND OF THE INVENTION

### Field of the Invention

The present invention relates to a catalyst composition that partially oxidizes a hydrocarbon to produce hydrogen and carbon monoxide, a hydrocarbon partial oxidizer including the catalyst composition, and a fuel cell system including the hydrocarbon partial oxidizer.

### Background Art

In order to reduce environmental loads, spreading of fuel cell systems has been promoted in recent years, and fuel cell systems for household have also been developed.

In a fuel cell system, for example, hydrogen is produced from a hydrocarbon through a partial oxidation reaction, a steam reforming reaction, and a water-gas shift reaction, and electric power is generated by a fuel cell using the produced hydrogen.

When the hydrocarbon is CH₄, the partial oxidation reaction, the steam reforming reaction, and the water-gas shift reaction are represented by the following equations.

Partial oxidation reaction: CH₄+½O₂→2H₂+CO

Steam reforming reaction: CH₄+H₂O→3H₂+CO

Water-gas shift reaction: CO+H₂O→H₂+CO₂

As a catalyst composition for the steam reforming reaction, there are known, for example, a catalyst composition in which a platinum group element and a Ce oxide are supported on an alumina carrier (e.g., an α-alumina carrier) (Patent Literature 1: Japanese Patent Laid-Open No. 2011-088066; and Patent Literature 2: Japanese Patent Laid-Open No. 2000-178007), and a catalyst composition in which a platinum group element, a Ce oxide, and a Zr oxide are supported on a γ-alumina carrier (Patent Literature 3: Japanese Translation of PCT International Application Publication No. 2004-507425).

### SUMMARY OF THE INVENTION

The catalyst composition that partially oxidizes a hydrocarbon to produce hydrogen and carbon monoxide produces hydrogen and carbon monoxide through the partial oxidation reaction of the hydrocarbon. Since this reaction is an exothermic reaction, the catalyst composition is exposed to a high temperature over an extended period. Therefore, the catalyst composition is required to have improved heat resistance. However, when a conventional catalyst composition is exposed to a high temperature, its catalytic activity is likely to deteriorate. For example, when the catalyst composition described in Patent Literatures 1 and 2 are exposed to high temperatures, there is a risk that sintering of the Ce oxide and sintering of the platinum group element associated with the sintering of the Ce oxide and/or embedding of the platinum group element may occur, resulting in a decrease in catalytic activity. The γ-alumina used as a carrier in the catalyst composition described in Patent Literature 3 has a large initial specific surface area, which is advantageous for surface enrichment of supported components, while it also has such a property that its specific surface area changes greatly upon exposure to a high temperature. Thus, when the catalyst composition described in Patent Literature 3 is exposed to a high temperature, there is a risk that not only the embedding of the platinum group element supported on the outer surface of the γ-alumina but also blockage of pores of the γ-alumina may occur and thus cause a reaction gas to hardly reach the supported components, resulting in a decrease in catalytic activity. Note that the term “high temperature” as used herein means a temperature of 200° C. or higher (especially, 300° C. or higher).

Therefore, an object of the present invention is to provide: a catalyst composition that partially oxidizes a hydrocarbon to produce hydrogen and carbon monoxide, the catalytic activity of which is unlikely to deteriorate even when the catalyst composition is exposed to a high temperature; a hydrocarbon partial oxidizer including the catalyst composition; and a fuel cell system including the hydrocarbon partial oxidizer.

In order to solve the above problems, the present invention provides the following inventions.

[1] A catalyst composition that partially oxidizes a hydrocarbon to produce hydrogen and carbon monoxide, the catalyst composition comprising: a carrier that comprises α-alumina; and supported components that are supported on the carrier,

wherein the supported components comprise at least one platinum group element, a Ce oxide, and a Zr oxide.

[2] The catalyst composition according to [1], wherein a content of the α-alumina is 70% by mass or more and 95% by mass or less, based on a mass of the catalyst composition.
[3] The catalyst composition according to [1] or [2], wherein a content of the Ce oxide in terms of CeO₂ is 8.5% by mass or more and 13.5% by mass or less, based on a mass of the catalyst composition.
[4] The catalyst composition according to any one of [1] to [3], wherein a content of the Zr oxide in terms of ZrO₂ is 0.3% by mass or more and 2.5% by mass or less, based on a mass of the catalyst composition.
[5] The catalyst composition according to any one of [1] to [4], wherein at least a part of the Ce oxide and at least a part of the Zr oxide are present in a form of a composite oxide.
[6] The catalyst composition according to [5], wherein in an X-ray diffraction pattern, at least one of peaks derived from the Ce oxide has a peak top at 20=47.61° to 49°.
[7] The catalyst composition according to any one of [1] to [6], wherein the at least one platinum group element comprises Pt and Rh.
[8] A hydrocarbon partial oxidizer that partially oxidizes a hydrocarbon to produce hydrogen and carbon monoxide, the hydrocarbon partial oxidizer comprising the catalyst composition according to any one of [1] to [7].
[9] A fuel cell system comprising: the hydrocarbon partial oxidizer according to [8]; and a fuel cell that generates electric power by a reaction between the hydrogen produced in the hydrocarbon partial oxidizer and an oxidant gas.

The present invention provides: a catalyst composition that partially oxidizes a hydrocarbon to produce hydrogen and carbon monoxide, the catalytic activity of which is unlikely to deteriorate even when the catalyst composition is exposed to a high temperature; a hydrocarbon partial oxidizer including the catalyst composition; and a fuel cell system including the hydrocarbon partial oxidizer.

### BRIEF DESCRIPTION OF THE DRAWINGS

FIG. 1 is a schematic view of a fuel cell system according to one embodiment of the present invention; and

FIG. 2 is a schematic view of an evaluating device used in Test Example 1.

### DETAILED DESCRIPTION OF THE INVENTION

### <<Catalyst Composition>>

The catalyst composition of the present invention is described below.

The form of the catalyst composition of the present invention is, for example, an aggregate of particles (powder form). The catalyst composition of the present invention may be formed into a desired shape such as a pellet or a layer.

The catalyst composition of the present invention is a catalyst composition that partially oxidizes a hydrocarbon to produce hydrogen and carbon monoxide.

When the hydrocarbon is CₙHₘ, the partial oxidation reaction is represented by the following equation.

Partial oxidation reaction: CₙHₘ+n/2O₂→m/2H₂+nCO

Conditions of the partial oxidation reaction are not particularly limited as long as the partial oxidation reaction can proceed. The temperature is preferably 100° C. or higher and 1,000° C. or lower, more preferably 200° C. or higher and 800° C. or lower, and even more preferably 300° C. or higher and 700° C. or lower.

The number of carbon atoms of the hydrocarbon is not particularly limited, and is, for example, 1 or more and 40 or less, preferably 1 or more and 30 or less, and more preferably 1 or more and 20 or less. Examples of the hydrocarbon include saturated aliphatic hydrocarbons, unsaturated aliphatic hydrocarbons, and aromatic hydrocarbons. The saturated aliphatic hydrocarbons and unsaturated aliphatic hydrocarbons may be chain-like or cyclic. The chain may be linear or branched. The aromatic hydrocarbons may be monocyclic or polycyclic.

Specific examples of the hydrocarbon include chain saturated aliphatic hydrocarbons such as methane, ethane, propane, butane, pentane, hexane, heptane, octane, nonane, decane, dodecane, tridecane, tetradecane, pentadecane, hexadecane, heptadecane, octadecane, nonadecane, and eicosane; alicyclic hydrocarbons such as cyclopentane and cyclohexane; unsaturated aliphatic hydrocarbons such as ethylene, propylene, butene, pentene, and hexene; and aromatic hydrocarbons such as benzene, toluene, xylene, and naphthalene. The hydrocarbon may have one or more substituents. Examples of the substituents include halogen atoms (e.g., F, Cl, Br, and I), hydroxy groups, alkoxy groups, carboxyl groups, ester groups, aldehyde groups, and acyl groups.

The hydrocarbon to be partially oxidized by the catalyst composition of the present invention may be a mixture of two or more hydrocarbons.

### <Carrier>

The catalyst compositions of the present invention contain a carrier.

The carrier is, for example, particulate. The particulate shape includes, for example, spherical (e.g., truly spherical and ellipsoidal), acicular, scaly (flaky), columnar (e.g., cylindrical and prismatic), and other shapes. In one embodiment, the carrier is spherical.

From the viewpoint of improving supporting properties of supported components, the carrier is preferably porous.

The carrier contains α-alumina. The α-alumina contained in the carrier forms an α-alumina phase. Since the α-alumina has a small initial specific surface area, the supported components are easily supported deep into the pores of the carrier. In addition, the change in specific surface area of the α-alumina is small upon exposure to a high temperature, making the blockage of the pores of the carrier less likely to occur. Therefore, even when the catalyst composition of the present invention is exposed to a high temperature, a state in which the reaction gas easily reaches the supported components supported deep into the pores of the carrier is maintained, making the catalytic activity of the catalyst composition unlikely to deteriorate.

The carrier may contain components other than the α-alumina. Examples of the components other than the α-alumina include alumina other than the α-alumina, silica, iron, and sodium. Examples of alumina other than the α-alumina include γ-alumina, θ-alumina, δ-alumina, and η-alumina.

From the viewpoint of more effectively suppressing the deterioration of the catalytic activity of the catalyst composition of the present invention, the content of the α-alumina in the carrier is preferably 90% by mass or more, more preferably 95% by mass or more, even more preferably 98% by mass or more, based on the mass of the carrier. The upper limit is 100% by mass.

The content of each element in the carrier can be measured by analyzing a sample obtained from the catalyst compositions of the present invention by energy dispersive X-ray spectroscopy (EDS) to obtain an element mapping, and performing EDS elemental analysis on designated particles in the obtained element mapping. Specifically, the content of each element in the designated particles can be measured by qualitatively identifying (color-coding) the carrier particles and other particles by elemental mapping and performing composition analysis (elemental analysis) on the designated particles. The content of alumina in the carrier can be calculated as an amount of Al in terms of Al₂O₃, based on the content of Al in the carrier. The crystal form of alumina in the carrier can be determined by X-ray diffraction (XRD).

The content of the carrier in the catalyst composition of the present invention can be appropriately adjusted. From the viewpoint of more effectively suppressing the deterioration of the catalytic activity of the catalyst composition of the present invention, the content of the carrier in the catalyst composition of the present invention is adjusted so that the content of α-alumina derived from the carrier is preferably 70% by mass or more and 95% by mass or less, more preferably 75% by mass or more and 95% by mass or less, and even more preferably 80% by mass or more and 95% by mass or less, based on the mass of catalyst composition of the present invention.

In a case where a composition of raw materials used in the production of the catalyst composition of the present invention is determined, the content of α-alumina in the catalyst composition of the present invention can be calculated from the composition of the raw materials used in the production of the catalyst composition of the present invention.

In a case where the composition of the raw materials used in the production of the catalyst composition of the present invention is not determined, the content of α-alumina in the catalyst composition of the present invention can be measured using a conventional method such as scanning electron microscopy-energy dispersive X-ray spectroscopy (SEM-EDX), X-ray fluorescence analysis (XRF), and inductively coupled plasma atomic emission spectrometry (ICP-AES). Specifically, the method is as follows.

First, a sample obtained from the catalyst composition of the present invention is analyzed by XRF or ICP-AES to identify 20 metal elements in descending order, from higher content to lower content. The 20 identified metal elements include Al.

The sample is then analyzed by SEM-EDX. In SEM-EDX, the 20 metal elements identified above are targeted for analysis. For each of 10 visual fields of the SEM, the total mole % of the 20 metal elements is set to 100 mole % to analyze the mole % of each metal element. The content of Al in the sample in terms of Al₂O₃ is calculated from the average value of the mole % of Al in the 10 visual fields.

The crystal form of alumina in the sample can be determined by X-ray diffraction (XRD).

### <Supported Components>

The catalyst composition of the present invention includes supported components supported on the carrier.

The expression “a component is supported on the carrier” means a state in which the component is physically or chemically adsorbed or retained on the outer surfaces or inner surfaces of the pores of the carrier. The fact that the component is supported on the carrier can be confirmed using, for example, a scanning electron microscope-energy dispersive X-ray analyzer (SEM-EDX). Specifically, in the elemental mapping obtained using SEM-EDX or the like, when the component and the carrier are present in the same region, it can be determined that the component is supported on the carrier.

The supported components include at least one platinum group element, a Ce oxide, and a Zr oxide. In other words, the catalyst composition of the present invention includes at least one platinum group element supported on the carrier, a Ce oxide supported on the carrier, and a Zr oxide supported on the carrier. The platinum group element is a catalytically active component, while the Ce oxide and the Zr oxide are cocatalyst components.

In a case where the Ce oxide coexists with the Zr oxide, sintering of the Ce oxide and sintering of the platinum group element associated with the sintering of the Ce oxide and/or embedding of the platinum group element associated with the sintering of the Ce oxide are less likely to occur than in a case where the Ce oxide alone exists. Therefore, even when the catalyst composition of the present invention is exposed to a high temperature, the catalytic activity of the catalyst composition is unlikely to deteriorate.

The at least one platinum group element can be selected from the group of platinum group elements consisting of Pt, Pd, Rh, Ru, Os, and Ir. From the viewpoint of more effectively expressing catalytic activity, the at least one platinum group element preferably includes Pt and Rh.

From the viewpoint of achieving a good balance between catalytic activity and production cost, the content of the platinum group element in terms of metal is preferably 0.1% by mass or more and 2.0% by mass or less, more preferably 0.3% by mass or more and 1.5% by mass or less, and even more preferably 0.5% by mass or more and 1.0% by mass or less, based on the mass of the catalyst composition of the present invention. The term “the content of the platinum group element in terms of metal” means the content of one platinum group element in terms of metal if the catalyst composition of the present invention contains the one platinum group element, and the total content of two or more platinum group elements in terms of metal when the catalyst composition of the present invention contains the two or more platinum group elements. The content of the platinum group element in the catalyst composition of the present invention can be calculated or measured in the same manner as the content of α-alumina in the catalyst composition of the present invention.

The platinum group element is supported on the carrier in a form capable of functioning as a catalytically-active component, for example, in the form of a metal composed of the platinum group element, an alloy containing the platinum group element, a compound containing the platinum group element (such as an oxide of the platinum group element), or the like. The catalytically-active component is, for example, particulate.

The Ce oxide is composed of a Ce element and an O element. Although a stoichiometric composition of the Ce oxide is represented by CeO₂, the Ce oxide may have a composition that deviates from the stoichiometric composition (non-stoichiometric composition). The composition of the Ce oxide contained in the catalyst composition of the present invention may be stoichiometric composition or non-stoichiometric composition (e.g., CeO_{1.8} and CeO_{1.9}). The composition of the Ce oxide is preferably represented by CeOx (x=1.50 to 2.00), more preferably by CeOx (x=1.75 to 2.00), and even more preferably by CeOx (x=1.80 to 2.00). The catalyst composition of the present invention may contain one type of Ce oxide, or two or more types of Ce oxides.

The Zr oxide is composed of a Zr element and an O element. Although a stoichiometric composition of the Zr oxide is represented by ZrO₂, the Zr oxide may have a composition that deviates from the stoichiometric composition (non-stoichiometric composition). The composition of the Zr oxide contained in the catalyst composition of the present invention may be stoichiometric composition or non-stoichiometric composition (e.g., ZrO_{1.8} and ZrO_{1.9}). The composition of the Zr oxide is preferably represented by ZrOx (x=1.50 to 2.00), more preferably by ZrOx (x=1.75 to 2.00), and even more preferably by ZrOx (x=1.80 to 2.00). The catalyst composition of the present invention may contain one type of Zr oxide, or two or more types of Zr oxides.

The Ce oxide and the Zr oxide are, for example, particulate.

From the viewpoint of more effectively suppressing the sintering of the Ce oxide and the sintering of the platinum group element associated with the sintering of the Ce oxide and/or the embedding of the platinum group element associated with the sintering of the Ce oxide to more effectively suppressing the deterioration of the catalytic activity of the catalyst composition of the present invention, the content of the Ce oxide in the catalyst composition of the present invention in terms of CeO₂ is preferably 8.5% by mass or more and 13.5% by mass or less, more preferably 9.0% by mass or more and 13.0% by mass or less, and even more preferably 9.5% by mass or more and 12.5% by mass or less, based on the mass of the catalyst composition of the present invention. The term “the content of the Ce oxide in terms of CeO₂” means the content of one Ce oxide in terms of CeO₂ when the catalyst composition of the present invention contains the one Ce oxide, and the total content of two or more Ce oxides in terms of CeO₂ when the catalyst composition of the present invention contains the two or more Ce oxides. The content of the Ce oxide in the catalyst composition of the present invention in terms of CeO₂ can be calculated or measured in the same manner as the content of α-alumina in the catalyst composition of the present invention.

From the viewpoint of more effectively suppressing the sintering of the Ce oxide and the sintering of the platinum group element associated with the sintering of the Ce oxide and/or the embedding of the platinum group element associated with the sintering of the Ce oxide to more effectively suppressing the deterioration of the catalytic activity of the catalyst composition of the present invention, the content of the Zr oxide in the catalyst composition of the present invention in terms of ZrO₂ is preferably 0.3% by mass or more and 2.5% by mass or less, more preferably 0.4% by mass or more and 2.0% by mass or less, and even more preferably 0.5% by mass or more and 1.5% by mass or less, based on the mass of the catalyst composition of the present invention. The term “the content of the Zr oxide in terms of ZrO₂” means the content of one Zr oxide in terms of ZrO₂ when the catalyst composition of the present invention contains the one Zr oxide, and the total content of two or more Zr oxides in terms of ZrO₂ when the catalyst composition of the present invention contains the two or more Zr oxides. The content of the Zr oxide in the catalyst composition of the present invention in terms of ZrO₂ can be calculated or measured in the same manner as the content of α-alumina in the catalyst composition of the present invention.

From the viewpoint of more effectively suppressing the sintering of the Ce oxide and the sintering of the platinum group element associated with the sintering of the Ce oxide and/or the embedding of the platinum group element associated with the sintering of the Ce oxide to more effectively suppressing the deterioration of the catalytic activity of the catalyst composition of the present invention, the ratio of the Ce oxide in terms of CeO₂ to the total content of the Ce oxide in terms of CeO₂ and the Zr oxide in terms of ZrO₂ is preferably 0.77 or more and 0.98 or less, more preferably 0.82 or more and 0.97 or less, and even more preferably 0.86 or more and 0.96 or less.

At least a part of the Ce oxide and at least a part of the Zr oxide are preferably present in the form of a composite oxide (a composite oxide containing Ce and Zr, hereinafter referred to as “Ce—Zr composite oxide”). The Ce—Zr composite oxide is, for example, particulate. In a case where the Ce oxide and the Zr oxide are present in the form of the Ce—Zr composite oxide, sintering of the Ce oxide and sintering of the platinum group element associated with the sintering of the Ce oxide and/or embedding of the platinum group element associated with the sintering of the Ce oxide are less likely to occur, compared to a case where the Ce oxide and the Zr oxide are present separately. Therefore, in the case where at least a part of the Ce oxide and at least a part of the Zr oxide are present in the form of the Ce—Zr composite oxide, the sintering of the Ce oxide and the sintering of the platinum group element associated with the sintering of the Ce oxide and/or the embedding of the platinum group element associated with the sintering of the Ce oxide are more effectively suppressed, thus more effectively suppressing the deterioration of the catalytic activity of the catalyst composition of the present invention.

The entire Ce oxide may be present in the form of the Ce—Zr composite oxide, and the entire Zr oxide may be present in the form of the Ce—Zr composite oxide.

In the Ce—Zr composite oxide, Ce, Zr, and O preferably form a solid solution phase. In addition to the solid solution phase, Ce, Zr, and O may form a single phase (Ce oxide phase and/or Zr oxide phase), which is a crystalline phase or an amorphous phase.

The presence of at least a part of the Ce oxide and at least a part of the Zr oxide in the form of the Ce—Zr composite oxide can be confirmed based on the fact that at least one peak derived from the Ce oxide has a peak top at 2θ=47.61° to 49° in an X-ray diffraction (XRD) pattern of a sample obtained from the catalyst composition of the present invention.

The XRD pattern can be obtained by performing XRD with CuKα using a sample obtained from the catalyst composition of the present invention and a commercially available X-ray diffraction device. Specific XRD conditions are as mentioned in Examples.

The catalyst composition of the present invention may include one or more other supported components supported on the carrier. Examples of such other components include oxides of rare earth metal elements other than Ce (e.g., Nd, La, Y, and Pr) and oxides of alkaline earth metal elements (e.g., Mg, Ca, Sr, and Ba). These oxides are, for example, particulate. At least a part of these oxides may form a composite oxide with the Ce oxide and/or the Zr oxide.

From the viewpoint of more effectively expressing the effects of the catalyst composition of the present invention, the total content of such other supported components is preferably 5% by mass or less, more preferably 3% by mass or less, and even more preferably 1% by mass or less, based on the mass of the catalyst composition of the present invention. The lower limit is zero. The content of such other supported components in the catalyst composition of the present invention can be calculated or measured in the same manner as the content of α-alumina in the catalyst composition of the present invention.

From the viewpoint of more effectively suppressing the deterioration of the catalytic activity of the catalyst composition of the present invention, the sum of the content of α-alumina derived from the carrier, the content of the Ce oxide supported on the carrier in terms of CeO₂, and the content of the Zr oxide supported on the carrier in terms of ZrO₂ is preferably 98.0% by mass or more and 99.9% by mass or less, more preferably 98.5% by mass or more and 99.7% by mass or less, and even more preferably 99.0% by mass or more and 99.5% by mass or less, based on the mass of the catalyst composition of the present invention.

### <Method of Producing Catalyst Composition>

The catalyst composition of the present invention can be produced, for example, by mixing a solution containing a salt of a platinum group element, a solution containing a cerium salt, a solution containing a zirconium salt, and carrier particles each containing α-alumina, followed by drying and calcination. The calcined product may be pulverized as necessary. The salt of the platinum group element may be, for example, a nitrate, an ammine complex salt, a chloride or the like. The cerium salt may be, for example, a nitrate, an acetate or the like. The zirconium salt may be, for example, a nitrate, an acetate or the like. The solvents contained in the solution containing the salt of the platinum group element, the solution containing the cerium salt, and the solution containing the zirconium salt are each, for example, water (such as ion exchanged water). The solution containing the salt of the platinum group element, the solution containing the cerium salt, and the solution containing the zirconium salt may each contain an organic solvent such as alcohol. The drying temperature is, for example, 70° C. or higher and 150° C. or lower. The calcination temperature is, for example, 400° C. or higher and 700° C. or lower. The calcination time is, for example, 1 hour or more and 10 hours or less. The calcination can be carried out, for example, in an air atmosphere.

The carrier particles each containing α-alumina used in the production of the catalyst composition of the present invention preferably have the following physical properties.

The BET specific surface area of the carrier particles is preferably 1 m²/g or more and 20 m²/g or less, and more preferably 2 m²/g or more and 10 m²/g or less.

The BET specific surface area is measured according to JIS R1626, “Measuring methods for the specific surface area of fine ceramic powders by gas adsorption using the BET method,” “6.2 Flow method,” “(3.5) Single-point method.” In this method, a nitrogen-helium gas mixture containing 30% by volume of nitrogen as an adsorption gas and 70% by volume of helium as a carrier gas is used as a gas. For example, BELSORP-MR6 manufactured by MicrotracBEL Corp. is used as a measurement device.

The pore volume (total pore volume in the range of a pore diameter of 3 nm or more and 500 μm or less) of the carrier particles is preferably 0.3 cm³/g or more and 0.6 cm³/g or less, and more preferably 0.4 cm³/g or more and 0.5 cm³/g or less.

The pore volume is measured by mercury porosimetry using a mercury porosimeter. The mercury porosimetry is performed in accordance with JIS R 1655:2003. For example, AutoPore IV 9520, manufactured by SHIMADZU CORPORATION, is used as a measuring device.

The average particle size of the carrier particles is preferably 1.0 mm or more and 5.0 mm or less, and more preferably 2.0 mm or more and 4.0 mm or less.

A method of measuring the average particle size of the carrier particles is as follows. The carrier particles are observed using an optical microscope, and unidirectional particle diameters (Feret diameters) of 100 carrier particles arbitrarily selected from the visual field are measured to define an average value as the average particle size of the carrier particles.

The packing density (tap density) of the carrier particles is preferably 0.70 g/cm³ or more and 1.00 g/cm³ or less, and more preferably 0.80 g/cm³ or more and 0.90 g/cm³ or less.

A method of measuring the packing density (tap density) of the carrier particles is as follows. 30 g of carrier particles is put in a 150-ml glass measuring cylinder and tapped 350 times in a stroke of 60 mm with a shaking specific gravity meter (KRS-409, manufactured by Kuramochi Kagaku Kikai Seisakusho K.K), and then the packing density (tap density) is measured.

### <<Fuel Cell System>>

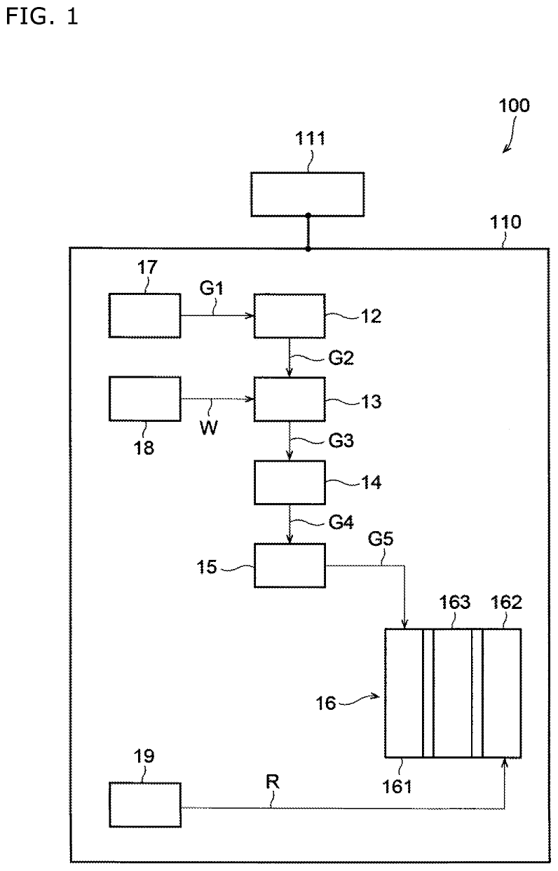

A fuel cell system 100 according to one embodiment of the invention is described below based on FIG. 1. Two or more of embodiments described below can be used in combination, and the combination of two or more embodiments is also encompassed by the present invention.

A fuel cell system 100 can be used for various applications, including stationary as well as automotive use and the like.

As illustrated in FIG. 1, the fuel cell system 100 includes a processing unit 110 and a control unit 111 that controls operation of the processing unit 110.

The various processes carried out by the processing unit 110 are described later.

The control unit 111 is, for example, a computer and includes a main control unit and a storage unit. The main control unit is, for example, a CPU (central processing unit), and controls the operation of the processing unit 110 by reading and executing programs, data, and the like stored in the storage unit. The storage unit is composed of, for example, a RAM (Random Access Memory), a ROM (Read Only Memory), a hard disk, or other storage devices, and stores programs, data, and the like that control processes executed by the processing unit 110.

As illustrated in FIG. 1, the processing unit 110 in the fuel cell system 100 includes a hydrocarbon partial oxidizer 12, a fuel cell 16, a raw material supplying unit 17, and an oxidant gas supplying unit 19.

As illustrated in FIG. 1, the processing unit 110 in the fuel cell system 100 may optionally include a mixer 13, a steam reformer 14, a shift reactor 15, and a steam supplying unit 18.

The raw material supplying unit 17 supplies a raw material gas G1 containing a hydrocarbon to the hydrocarbon partial oxidizer 12. The raw material gas G1 includes one or more hydrocarbon-containing materials selected from, for example, city gas, natural gas, LPG, naphtha, gasoline, kerosene, and light oil. The raw material gas G1 may contain hydrogen, water, carbon dioxide, carbon monoxide, nitrogen, oxygen, and the like. In one embodiment, the raw material gas G1 contains air. The air may be mixed with a hydrocarbon in the raw material supplying unit 17, or may be mixed with the hydrocarbon on the way that the hydrocarbon is supplied from the raw material supplying unit 17 to the hydrocarbon partial oxidizer 12.

In one embodiment, the raw material supplying unit 17 includes a tank for storing the raw material gas G1, a supply pipe for supplying the raw material gas G1 in the tank to the hydrocarbon partial oxidizer 12, and a pump provided in the supply pipe, and supplies the raw material gas G1 in the tank to the hydrocarbon partial oxidizer 12 through the supply pipe by using sucking and discharging forces of the pump.

The raw material supplying unit 17 may include a desulfurizer for desulfurizing the raw material gas G1. In one embodiment, the desulfurizer includes a container and a desulfurizing agent contained within the container. As the desulfurizing agent, a known agent can be used.

The O₂/C (ratio of the molar amount of oxygen molecules to the molar amount of carbon atoms contained in the hydrocarbon) in the raw material gas G1 can be appropriately set depending on a desired yield of hydrogen, characteristics of the fuel cell system, reaction conditions, and the like.

The hydrocarbon partial oxidizer 12 includes the catalyst composition of the present invention. In one embodiment, the hydrocarbon partial oxidizer 12 includes a container and the catalyst composition of the invention contained within the container.

The raw material gas G1 supplied to the hydrocarbon partial oxidizer 12 is brought into contact with the catalyst composition of the present invention, and a hydrocarbon in the raw material gas G1 is partially oxidized to produce a reformed gas G2 containing hydrogen and carbon monoxide.

When the hydrocarbon is CₙHₘ, the partial oxidation reaction is represented by the following equation.

Partial oxidation reaction: CₙHₘ+n/2O₂→m/2H₂+nCO

Conditions of the partial oxidation reaction in the hydrocarbon partial oxidizer 12 are not particularly limited as long as the partial oxidation reaction can proceed. The temperature is preferably 100° C. or higher and 1,000° C. or lower, more preferably 200° C. or higher and 800° C. or lower, and even more preferably 300° C. or higher and 700° C. or lower.

In one embodiment, the reformed gas G2 produced in the hydrocarbon partial oxidizer 12 is supplied to the fuel cell 16. The reformed gas G2 is supplied to an anode electrode 161 side of the fuel cell 16. The fuel cell 16 generates electric power by electrochemical reaction between hydrogen in the reformed gas G2 and oxygen in an oxidant gas R supplied by the oxidant gas supplying unit 19.

Optionally, a mixer 13 may be provided. In a case where the mixer 13 is provided, the reformed gas G2 produced in the hydrocarbon partial oxidizer 12 is supplied to the mixer 13.

Optionally, a steam supplying unit 18 may be provided. The steam supplying unit 18 supplies steam W to the mixer 13. The steam supplying unit 18 may include a steam generating unit for generating the steam W from water. In one embodiment, the steam supplying unit 18 includes a tank for storing the steam W, a supply pipe for supplying the steam in the tank to the mixer 13, and a pump provided in the supply pipe, and supplies the steam W in the tank to the mixer 13 through the supply pipe by using sucking and discharging forces of the pump.

In the mixer 13, the reformed gas G2 and the steam W are mixed to generate a mixed gas G3 containing the reformed gas G2 and the steam W. The generated mixed gas G3 is supplied to the steam reformer 14.

Optionally, the steam reformer 14 may be provided. The steam reformer 14 includes a catalyst composition for steam reforming reaction. In one embodiment, the steam reformer 14 includes a container and the catalyst composition for steam reforming reaction contained within the container. As the catalyst composition for the steam reforming reaction, a known composition can be used.

The mixed gas G3 supplied to the steam reformer 14 is brought into contact with the catalyst composition for steam reforming reaction, and a hydrocarbon in the mixed gas G3 is steam-reformed to produce a reformed gas G4 containing hydrogen and carbon monoxide.

When the hydrocarbon is CₙHₘ, the steam reforming reaction is represented by the following equation.

Steam reforming reaction: CₙHₘ+nH₂O→(m/2+n)H₂+nCO

As conditions of the steam reforming reaction in the steam reformer 14, known conditions can be applied.

In one embodiment, the reformed gas G4 produced in the steam reformer 14 is supplied to the fuel cell 16. The reformed gas G4 is supplied to an anode electrode 161 side of the fuel cell 16. The fuel cell 16 generates electric power by electrochemical reaction between hydrogen in the reformed gas G4 and oxygen in an oxidant gas R supplied by the oxidant gas supplying unit 19.

Optionally, a shift reactor 15 may be provided. In a case where the shift reactor 15 is provided, the reformed gas G4 produced in the steam reformer 14 is supplied to the shift reactor 15. The shift reactor 15 includes a catalyst composition for water-gas shift reaction. In one embodiment, the shift reactor 15 includes a container and the catalyst composition for water-gas shift reaction contained within the container. As the catalyst composition for water-gas shift reaction, a known composition can be used.

The reformed gas G4 supplied to the shift reactor 15 is brought into contact with the catalyst composition for water-gas shift reaction, and carbon monoxide and steam in the reformed gas G4 react to produce a fuel gas G5 containing hydrogen and carbon dioxide.

The water-gas shift reaction is represented by the following equation.

Water-gas shift reaction: CO+H₂O→H₂+CO₂

As conditions of the water-gas shift reaction in the shift reactor 15, known conditions can be applied.

In one embodiment, the fuel gas G5 produced in the shift reactor 15 is supplied to the fuel cell 16. The fuel gas G5 is supplied to the anode electrode 161 side of the fuel cell 16. The fuel cell 16 generates electric power by electrochemical reaction between hydrogen in the fuel gas G5 and oxygen in an oxidant gas R supplied by the oxidant gas supplying unit 19.

The oxidant gas supplying unit 19 supplies an oxidant gas R to the fuel cell 16. The oxidant gas R is, for example, air. The oxidant gas R is supplied to a cathode electrode 162 side of the fuel cell 16. In one embodiment, the oxidant gas supplying unit 19 includes a tank for storing the oxidant gas R, a supply pipe for supplying the oxidant gas R in the tank to the fuel cell 16, and a pump provided in the supply pipe, and supplies the oxidant gas R in the tank to the fuel cell 16 through the supply pipe by using sucking and discharging forces of the pump.

As the fuel cell 16, a known fuel cell can be used. The fuel cell 16 is, for example, a solid oxide fuel cell (SOFC). A plurality of fuel cells 16 may be laminated to form a fuel cell stack.

The fuel cell 16 is, for example, an electrolyte/electrode assembly (MEA) in which the anode electrode 161 and the cathode electrode 162 are respectively provided on one surface and the other surface of an electrolyte 163 composed of an oxide ion conductor such as stabilized zirconia.

At the anode electrode 161, a reaction proceeds in which hydrogen reacts with oxide ions to form water and release electrons, while at the cathode electrode 162, a reaction proceeds in which oxygen gains electrons to become oxide ions. An electric load (not shown) may be connected electrically to the anode electrode 161 and the cathode electrode 162.

### EXAMPLES

### Example 1

Under an environment of 120° C., 100 g of spherical α-alumina pellets (specific surface area: about 4 m²/g, pore volume: about 0.43 cm³/g, packing density: about 0.86 g/cm³, average particle size: about 2.5 mm) were allowed to stand and dried for 5 hours to give dried alumina pellets.

A platinum nitrate solution and a rhodium nitrate solution were each weighed so that the sum of the content of Pt in terms of metal and the content of Rh in terms of metal was 0.5% by mass or more and 1.0% by mass or less, based on the mass of the final product, Pt—Rh-ceria-zirconia-supporting calcined alumina pellet. A cerium nitrate solution and a zirconium nitrate solution were each weighed so that the content of the Ce oxide in terms of CeO₂ and the content of the Zr oxide in terms of ZrO₂ were as shown in Table 1, based on the mass of the final product, Pt—Rh-ceria-zirconia-supporting calcined alumina pellet. The solutions were mixed and stirred for 10 minutes to give a mixed solution. The obtained mixed solution was charged into the dried alumina pellets and stirred for 10 minutes to allow the alumina pellets to absorb the mixed solution. The content of the dried alumina pellets charged was adjusted so that the content of solid matter of the alumina pellets absorbed with the mixed solution was 100 g in total. The alumina pellets having absorbed the mixed solution were dried under an environment of 120° C. until no weight change was observed to give Pt—Rh-cerium-zirconium-supporting dried alumina pellets.

The obtained Pt—Rh-cerium-zirconium-supporting dried alumina pellets were calcined at 500° C. for 3 hours to give Pt—Rh-ceria-zirconia-supporting calcined alumina pellets. The composition of the obtained Pt—Rh-ceria-zirconia-supporting calcined alumina pellets is shown in Table 1. Note that in Table 1, “% by mass” in Example 1 is based on the mass of the Pt—Rh-ceria-zirconia-supporting calcined alumina pellet.

An X-ray diffraction (XRD) pattern of the Pt—Rh-ceria-zirconia-supporting calcined alumina pellets was measured using X-ray diffraction (XRD). XRD was performed using an X-ray diffractometer under the following conditions: X-ray source: CuKα, operating axis: 2θ/θ, measuring method: continuous, counting unit: cps, starting angle: 5°, ending angle: 80°, step width: 0.02°, scanning speed: 10.0°/min, voltage: 40 kV, and current: 15 mA.

In the measured X-ray diffraction pattern, there was a peak derived from a Ce oxide having a peak top at 2θ=47.61° to 49° (specifically, 2θ=47.68°).

### Comparative Example 1

The platinum nitrate solution and the rhodium nitrate solution were weighed so that the content (% by mass) of Pt in terms of metal and the content (% by mass) of Rh in terms of metal were each the same as in Example 1, based on the mass of the final product, Pt—Rh-ceria-supporting calcined alumina pellet. The cerium nitrate solution was weighed so that the content of the Ce oxide in terms of CeO₂ was as shown in Table 1, based on the mass of the final product, Pt—Rh-ceria-supporting calcined alumina pellet. The same operation as in Example 1 was carried out to give Pt—Rh-cerium-supporting dried alumina pellets, except that the solutions were mixed and stirred for 10 minutes and a mixed solution was obtained (a zirconium nitrate solution was not used). The obtained Pt—Rh-cerium-supporting dried alumina pellets were calcined at 500° C. for 3 hours to give Pt—Rh-ceria-supporting calcined alumina pellets. The composition of the obtained Pt—Rh-ceria-supporting calcined alumina pellets is shown in Table 1. Note that in Table 1, “% by mass” in Comparative Example 1 is based on the mass of the Pt—Rh-ceria-supporting calcined alumina pellet.

An X-ray diffraction (XRD) pattern of the Pt—Rh-ceria-supporting calcined alumina pellets was obtained using X-ray diffraction (XRD). XRD was performed in the same manner as in Example 1. In the measured X-ray diffraction pattern, there was a peak derived from a Ce oxide having a peak top at 2θ=47.60°, but there was no peak derived from a Ce oxide having a peak top at 2θ=47.61° to 49°.

### Comparative Example 2

The same operation as in Example 1 was carried out to give Pt—Rh-cerium-zirconium-supporting dried alumina pellets, except that under an environment of 120° C., 100 g of spherical γ-alumina pellets (specific surface area: about 210 m²/g, pore volume: about 0.43 cm³/g, packing density: about 0.85 g/cm³, average particle size: about 2.5 mm) were allowed to stand and dried for 5 hours, and dried alumina pellets were obtained. Note that the content (% by mass) of Pt in terms of metal and the content (% by mass) of Rh in terms of metal were each the same as in Example 1, based on the mass of the final product, Pt—Rh-ceria-zirconia-supporting calcined alumina pellet. The obtained Pt—Rh-cerium-zirconium-supporting dried alumina pellets were calcined at 500° C. for 3 hours to give Pt—Rh-ceria-zirconia-supporting calcined alumina pellets. The composition of the obtained Pt—Rh-ceria-zirconia-supporting calcined alumina pellets is shown in Table 1. Note that in Table 1, “% by mass” in Comparative Example 2 is based on the mass of the Pt—Rh-ceria-zirconia-supporting calcined alumina pellet.

An X-ray diffraction (XRD) pattern of the Pt—Rh-ceria-zirconia-supporting calcined alumina pellets were obtained using X-ray diffraction (XRD). XRD was performed in the same manner as in Example 1. In the measured X-ray diffraction pattern, there was a peak derived from a Ce oxide having a peak top at 2θ=47.54°, but there was no peak derived from a Ce oxide having a peak top at 2θ=47.61° to 49°.

TABLE 1

| | Contents of |
|---|---|
| | supported |
| Carrier | components |

| | |
|---|---|
| Content | (% by mass) |

| | Type | (% by mass) | CeO₂ | ZrO₂ |
|---|---|---|---|---|
| Example 1 | α-alumina | 87 | 11 | 1 |
| Comparative | α-alumina | 87 | 12 | — |
| Example 1 | | | | |
| Comparative | γ-alumina | 87 | 11 | 1 |
| Example 2 | | | | |

### Test Example 1

### (1) Accelerated Aging Treatment

The Pt—Rh-ceria-zirconia-supporting calcined alumina pellets obtained in Example 1 were installed in a tubular furnace, and a simulated fuel gas containing air and hydrocarbon was circulated. In the simulated fuel gas, the ratio of the molar amount of oxygen molecules derived from the air to the molar amount of carbon atoms derived from the hydrocarbon (O₂/C ratio) was adjusted to be 0.5. The temperature of the tubular furnace was increased to 1,000° C. at a temperature increasing rate of 5° C./min while the simulated fuel gas was circulated, and the Pt—Rh-ceria-zirconia-supporting calcined alumina pellets obtained in Example 1 were treated at 1,000° C. for 24 hours to prepare an aging-treated sample.

The Pt—Rh-ceria-supporting calcined alumina pellets obtained in Comparative Example 1 and the Pt—Rh-ceria-zirconia-supporting calcined alumina pellets obtained in Comparative Example 2 were also subjected to the same accelerated aging treatment as described above to prepare aging-treated samples.

### (2) Ignition Temperature Measurement

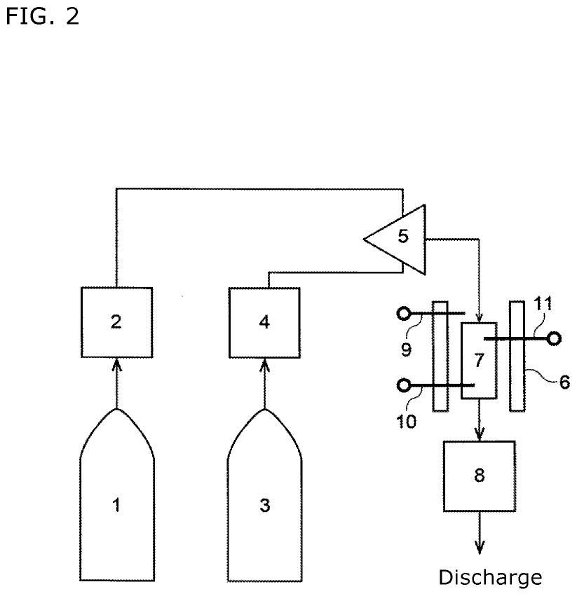

The evaluation device illustrated in FIG. 2 was used to measure the ignition temperature of the aging-treated samples.

In the evaluation device illustrated in FIG. 2, the flow rates of fuel gas (city gas) supplied from a cylinder 1 and air supplied from a cylinder 3 are adjusted by a gas mass flow controller 2 and a gas mass flow controller 4, respectively. The fuel gas supplied from the cylinder 1 and the air supplied from the cylinder 3 are mixed in a mixing unit 5 and transferred to a partial oxidation catalyst 7 contained within a stainless steel container in an electric furnace 6, and the gas partially oxidized by the partial oxidation catalyst 7 is discharged through a bubbler 8. Note that each of the aging-treated samples obtained in (1) above were used as the partial oxidation catalyst 7.

The ignition temperature and the temperature after heating were measured according to the following procedure. Note that the amount of the partial oxidation catalyst 7 in the stainless steel container in the electric furnace 6 was adjusted to a volume of 1.5 cm³, and the flow rates of the fuel gas and air supplied to the partial oxidation catalyst 7 were adjusted so that the space velocity (SV) divided by the catalyst volume was about 30,000 h⁻¹, and the ratio of the molar amount of oxygen molecules in the supplied air to the molar amount of carbon atoms in the supplied fuel gas (O₂/C ratio) was 0.5.

(a) The temperature of the electric furnace was increased until the temperature of the furnace, as measured by a thermocouple 9, reached 200° C.

(b) The setting temperature of the electric furnace was increased by 10° C., the temperature of the partial oxidation catalyst 7 was measured by a thermocouple 10, and the temperature of an inlet gas was measured by a thermocouple 11 located in front of the partial oxidation catalyst 7.

(c) In a case where the difference between the temperature of the inlet gas and the temperature of the partial oxidation catalyst 7 after the stop of the temperature rise was less than 20° C., it was determined that ignition did not occur in the temperature range, and the procedure of (b) was performed again. Herein, the stop of the temperature rise indicates that a change in the temperature of the partial oxidation catalyst 7 is 1° C./min or less.

(d) In a case where the difference between the temperature of the inlet gas and the temperature of the partial oxidation catalyst 7 after the stop of the temperature rise was 20° C. or more, it was determined that ignition has occurred, and the temperature of the partial oxidation catalyst 7 before the start of the temperature rise was defined as the ignition temperature while the temperature after the stop of the temperature rise was defined as the temperature after heating. Table 2 shows results.

TABLE 2

| | Ignition | Temperature after |
|---|---|---|
| | temperature (° C.) | heating (° C.) |
| Example 1 | 500 | 590 |
| Comparative | 535 | 600 |
| Example 1 | | |
| Comparative | 585 | 610 |
| Example 2 | | |

In the aging-treated sample of Example 1, even when exposed to a high temperature, a state in which the reaction gas easily reaches the supported components supported deep into the pores of the carrier was maintained by using α-alumina as the carrier. Furthermore, because of the inclusion of the Zr oxide, the effects of preventing the sintering of the platinum group element associated with the sintering of the Ce oxide and/or the embedding of the platinum group element associated with the sintering of the Ce oxide were preferably exhibited. As a result, the activity of the catalyst did not decrease, the state in which the partial oxidation reaction easily occurred was maintained, and showed the low ignition temperature.

In the aging-treated sample of Comparative Example 1, because the Zr oxide was not contained, the effects of preventing the sintering of the Ce oxide and the sintering of the platinum group element associated with the sintering of the Ce oxide and/or the embedding of the platinum group element associated with the sintering of the Ce oxide were not exhibited. As a result, the activity of the catalyst decreased, the partial oxidation reaction was less likely to occur, and ignition occurred at a temperature higher than that in Example 1.

In the aging-treated sample of Comparative Example 2, because γ-alumina was used as the carrier, the embedding of the platinum group element supported on the outer surface thereof and the blockage of the pores of the γ-alumina occurred and thus caused the reaction gas to hardly reach the supported components. As a result, the activity of the catalyst decreased, the partial oxidation reaction was less likely to occur, and ignition occurred at a temperature higher than that in Example 1.

### REFERENCE SIGNS LIST

100 Fuel cell system
110 Processing unit
111 Control unit
12 Hydrocarbon partial oxidizer
13 Mixer
14 Steam reformer
15 Shift reactor
16 Fuel cell
17 Raw material supplying unit
18 Steam supplying unit
19 Oxidant gas supplying unit

What is claimed is:

1. A catalyst composition that partially oxidizes a hydrocarbon to produce hydrogen and carbon monoxide, the catalyst composition comprising: a carrier that comprises α-alumina; and supported components that are supported on the carrier,
wherein the supported components comprise at least one platinum group element, a Ce oxide, and a Zr oxide.

2. The catalyst composition according to claim 1, wherein a content of the α-alumina is 70% by mass or more and 95% by mass or less, based on a mass of the catalyst composition.

3. The catalyst composition according to claim 1, wherein a content of the Ce oxide in terms of CeO₂ is 8.5% by mass or more and 13.5% by mass or less, based on a mass of the catalyst composition.

4. The catalyst composition according to claim 1, wherein a content of the Zr oxide in terms of ZrO₂ is 0.3% by mass or more and 2.5% by mass or less, based on a mass of the catalyst composition.

5. The catalyst composition according to claim 1, wherein at least a part of the Ce oxide and at least a part of the Zr oxide are present in a form of a composite oxide.

6. The catalyst composition according to claim 5, wherein in an X-ray diffraction pattern, at least one of peaks derived from the Ce oxide has a peak top at 2θ=47.61° to 49°.

7. The catalyst composition according to claim 1, wherein the at least one platinum group element comprises Pt and Rh.

8. A hydrocarbon partial oxidizer that partially oxidizes a hydrocarbon to produce hydrogen and carbon monoxide, the hydrocarbon partial oxidizer comprising the catalyst composition according to claim 1.

9. A fuel cell system comprising: the hydrocarbon partial oxidizer according to claim 8; and a fuel cell that generates electric power by a reaction between the hydrogen produced in the hydrocarbon partial oxidizer and an oxidant gas.
